(19) United States
(12) Patent Application Publication
(10) Pub. No.: US 2014/0047371 A1
(43) Pub. Date: Feb. 13, 2014

(54) Vehicle Event Playback Apparatus and Methods

(71) Applicants: Jason Palmer, San Diego, CA (US); Staven Sljivar, San Diego, CA (US)

(72) Inventors: Jason Palmer, San Diego, CA (US); Staven Sljivar, San Diego, CA (US)

(73) Assignee: Smartdrive Systems Inc.

(21) Appl. No.: 13/571,445

(22) Filed: Aug. 10, 2012

(51) Int. Cl. G06F 3/0484

(52) U.S. Cl. CPC G06F 3/0484
USPC 715/771

(57) ABSTRACT

Vehicle event data playback systems have been devised and invented to provide authorized users means for advanced visual review. Detailed circumstances relating to vehicle operation are visually presented in these unique playback systems. In particular, a group of cooperating visual display devices operate in conjunction with each other to effect a detailed visual presentation of a vehicle's operational states. An interested party is afforded a high level of access to many data types in highly graphical and intuitive arrangements. Further, data replay access is enhanced by slow motion, fast forward, loop repeat, among others which have never before been associated with these data types nor with the compound visual presentations first taught in the accompanying disclosure.

### BACKGROUND OF THE INVENTION

1. Field

The following invention disclosure is generally concerned with multi-media playback systems and specifically concerned with playback systems for vehicle event record playback and analysis.

2. Prior Art

Multi-media players are designed and configured to run on computer systems and play back systems data files of particular nature and configuration. For example, a very popular multi-media player commonly known as ‘Windows Media Player®’ can play video encoded media files consistent with a format defined in the MP4 standard among others.

Besides common video playback systems, modern computing systems ubiquitously include user interface mechanisms by which a user might drive execution of a playback via interactive control objects.

One example of a user interface which affords a user improved functionality of displayed information is presented in U.S. Pat. No. 8,176,431 by Scannell et al, published May 8, 2012. In this presentation, the inventors configure their controls in a ‘web browser add-on’ system in which a menu of selectable options are displayed whereby these options are determined by ‘user-centric’ information including web-surfing characteristics, device information, network-authentication information.

Yano et al of U.S. Pat. No. 8,159,506 show how graphical user interfaces with interactive control objects might be used to effect image displaying methods. In a display field of one control object, image information is presented to a user. Depending upon certain actions taken by an operator/user, the manner in which images are displayed is changed. The image display control is responsive to the other controls of the graphical user interface.

One very important invention includes a concept relating to time synchronized presentation of information at a plurality of controls. Presented in U.S. Pat. No. 8,126,309, which recently published on Feb. 28, 2012, the invention relates to video playback. In particular, inventor Sakai instructs that video playback be effected in conjunction with supporting related data including associations with a timestamp. As a video stream is advanced in time, related data is presented synchronously therewith. By careful management of timestamps, the video playback assures data presented in the interface relates particularly and precisely to a frame-by-frame notion of the image series.

While systems and inventions of the art are designed to achieve particular goals and objectives, some being no less than remarkable, known systems have nevertheless include limitations which prevent their use in new ways now possible. Inventions of the art are not used and cannot be used to realize advantages and objectives of the teachings presented herefollowing.

### SUMMARY OF THE INVENTION

Comes now, Jason Palmer and Slaven Sljivar with inventions of a vehicle event record playback systems including devices and methods. It is a primary function of these systems to provide review and analysis means particularly suited and arranged in view of information captured by high performance vehicle event recorders. In contrast to the prior art, systems first presented here do not suffer limitations which prevent their use for display or data captured in high performance vehicle event recorders.

Specialized high-performance vehicle event recorders produce data-rich event record datasets in response to anomalies detected during vehicle operation. Because event record datasets can contain considerable amounts of data in many data formats and arrangements, they tend to be very difficult to parse, read, interpret, and use. Heretofore, some vehicle event recorder data has been manually reviewed and certain data subsets of greatest importance are sometimes manually developed from raw data into visual presentations by way of standard software such as spreadsheet plotting utilities. Known vehicle event recorder playback systems may support some basic video playback functionality, but those systems do not support presentation of many types of data which may be collected in a vehicle event recorder.

Vehicle event data playback systems presented herefollowing include advanced playback of vehicle event recorder data. These vehicle event record playback systems include visual devices are particularly arranged to express vehicle performance data in graphical, image and alphanumeric forms. These systems are arranged to present data in logical arrangements whereby highly diverse datatypes collected at various vehicle subsystems are presented in time synchronized schemes along with a plurality of complementary data. Data presented in this fashion permits far greater analysis to enable reviewers to devise highly useful coaching feedback.

In one first example, vehicle performance data collected by way of a vehicle's onboard diagnostic system (OBD) and engine control unit (ECU) is included and associated with other data collected at the same (or nearly same) instant in time. An event record is prepared in a manner where all data measurements are associated with a timestamp or other time synchronization scheme. In this way, synchronized playback of data from a plurality of data sources is enabled.

On playback, a human reviewer is presented with simultaneous views and expressions of many data elements, each presented in a visual nature on a common display field of a unique graphical user interface. Since these data elements often have a high level of interdependence, simultaneous expression of their instantaneous values in a time sequenced series playback enables a most advanced system for vehicle event record review.

Graphical user interfaces of these systems include control objects which are responsive to data values of vehicle event recorder event record datasets and may be expressed visually. Combinations of various related control objects operate together in synchronization to characterize and describe particular actions and states associated with a vehicle and its many subsystems during a recorded exception event.

Particularly, these control objects are arranged to visually express data collected from vehicle subsystems in both graphical and alphanumeric forms. In some cases, data associated with standard OBD and ECU systems and to present that data in a visual form in conjunction with simultaneous playback of related video.

According to the specifications here, control objects of a graphical user interface are coupled to a single event timeline whereby presentation of data at each of these control objects strictly conforms to the event timing.

In most important versions of these systems, ‘video playback’ is a first core feature accordingly, sophisticated video players are generally included as a primary element of these graphical user interfaces. Video player systems of these devices may include those suitable for playback of common video captured at a vehicle event recorder video camper and in addition thereto, these video players are also suitable for playback of virtual video where ‘virtual video’ includes image series playback where the images are from sources other than a vehicle event recorder. These may include forward and aft video camera views, street view image series, mapview image series, and even birdseye view playback.

Another important control object found in the these playback apparatus include graphical representations of acceleration data in one or more coupled controls. One very unique and important feature relates to a notation facility which is further coupled to an event timeline. The notation facility permits replay of manually prepared notes to which a time Association has been made and assigned in synchronization with event replay.

### Objectives of the Invention

It is a primary object of the invention to provide vehicle event record playback systems.

It is an object of the invention to synchronously playback a plurality of datastreams via a unitary interface system.

It is an object of the invention to provide vehicle event record playback systems with multiview video playback.

It is a further object to provide graphical controls which are bound to data collected via automotive OBD and ECU systems.

It is an object of the invention systems to include a notation field which includes elements associated with time instants of vehicle event record datasets.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is a line drawing view of one graphical user interface which illustrates a version of these systems;

FIG. 2 presents one version of a timeline control time synchronized with images presented in related image control objects;

FIG. 3 illustrates side-by-side, time synchronized video players coupled to two video data sources related via a vehicle event record dataset;

FIGS. 4-6 show additional versions of side-by-side time synchronized video players similarly coupled to related video from sources other than vehicle event recorders;

FIG. 7 illustrates in isolation, coupled control objects designed to express data both graphically and alphanumerically—the control objects being further coupled and responsive to a vehicle event timeline;

FIG. 8 includes illustrations of a version of vehicle speed and engine speed control objects synchronized and commonly coupled to a timeline control;

FIG. 9 is a drawing of a plurality of control objects which are bound to standard vehicle sensors via on-board diagnostics and/or engine control unit systems of a subject vehicle;

FIG. 10 presents a special time responsive notation field type control object and its contents which are bound and responsive to an event timeline; and

FIG. 11 indicates additional auxillary elements which may be included in some of these graphical user interface versions.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Control Object

A ‘control object’ is a device which may be coupled to data or a data stream and is responsive thereto. Control objects include: parametric input couplings and data interfaces, underlying logic code which defines performance, a visual expression, [an event set, triggers, instantaneous state, other].

### Event Timeline

An event timeline has a start-time and an end-time and continuous period therebetween. An event record dataset includes an event timeline definition for events recorded at a vehicle event recorder.

### ‘Virtual Video’

A virtual video is comprised of a series of images, said images being formed by something other than the video camera of a vehicle event recorder, for example a series of map images played in sequence over some prescribed timeline.

### Event Record Dataset

An event record dataset is comprised of data capture during an event timeline from a plurality of sensors and measurement systems including coupled data and information systems such as the Internet. Further, an event record dataset includes data captured locally at a vehicle event recorder including video images.

### PREFERRED EMBODIMENTS OF THE INVENTION

A vehicle event data playback apparatus in accordance with these teachings includes graphical user interfaces specifically designed with particular functionality and cooperation with respect to vehicle event recorders and the event dataset information they produce. Such graphical user interfaces may be highly interactive and responsive to user/operator inputs effected by a computer peripheral devices. For example, a ‘point-and-click’ action of a computer mouse, among others.

These systems (apparatus and methods) include particular couplings to vehicle event recorders and data captured in vehicle event recorders. These systems including a logic processor, display device and graphical user interface, receive as input vehicle event recorder datasets. Prescribed program code may be executed at the logic processor to operate on datasets received from vehicle event recorders. Data from these datasets are passed into control objects as parametric input to drive the various visual states of the control objects.

### Control Objects

Graphical user interfaces of vehicle event recorder dataset playback systems presented herein are comprised of a plurality of control objects. These control objects may include visual appearances which may change in response to user interaction and specific data values of a particular subject dataset under review. Some of these control objects as they are interactive and responsive to ‘point-and-click’ or ‘click and drag’ user interactions. Control objects of these systems are specifically coupled to and designed to cooperate with data types and data objects unique to vehicle event recorder event record datasets and they are not suitable for use as general purpose controls in contrast to those found in common graphical user interface programming packages.

As a first important feature of control objects of these systems, the control objects are specifically designed with appearance and data ranges which agree with the particular information generated by vehicle event recorders in view of operation of vehicles. The control objects of these graphical user interfaces have a nature and scheme such that they best support visual expression of data which is contained in a vehicle event record event dataset. Many important illustrative examples are included herefollowing.

Control objects of these systems not only include arrangements which support a range of visual expression, they additionally include logic code. Logic code (not visible to a user) operates to receive data input, parse that data, process the data in accordance with prescribed algorithms which are part of the logic code and further to provide outputs which may include adjustments the visual states of the control object.

### Timeline Control Object

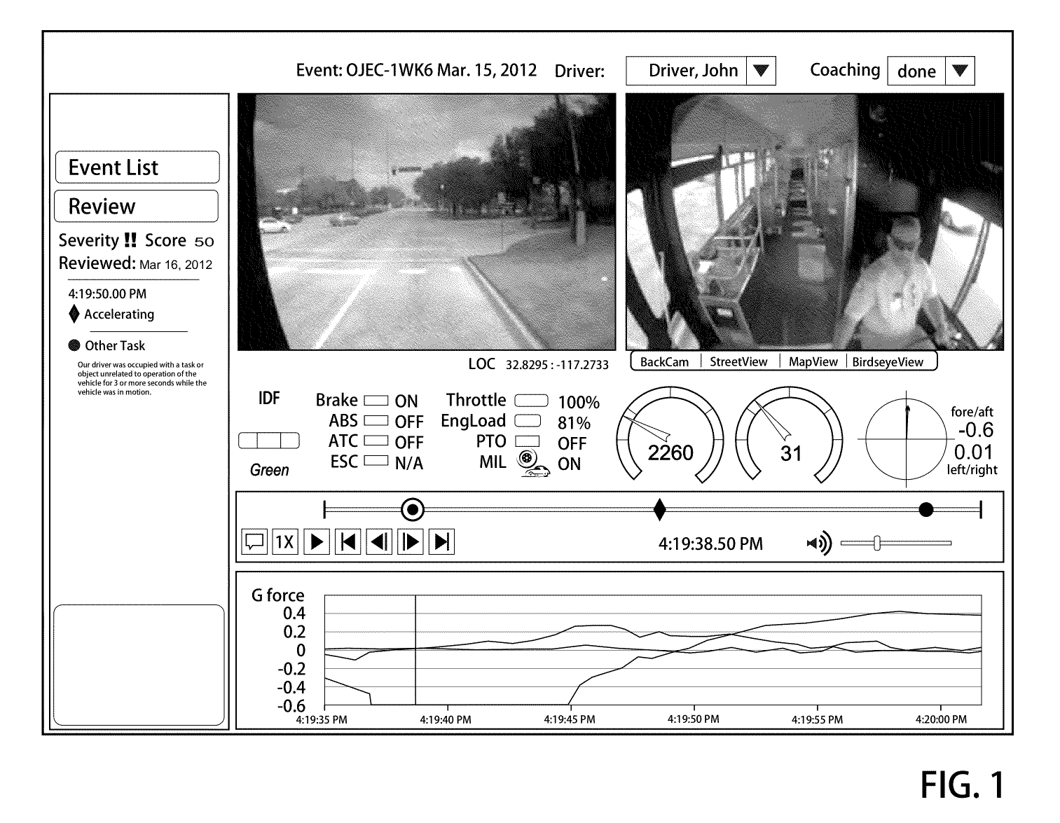

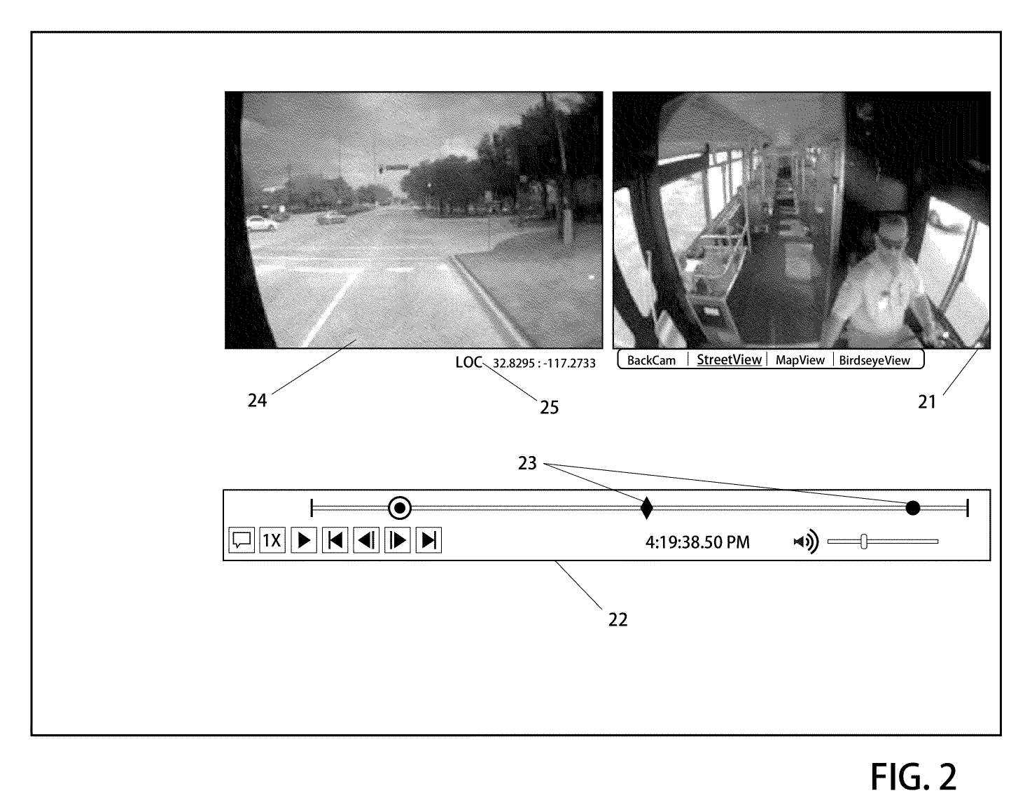

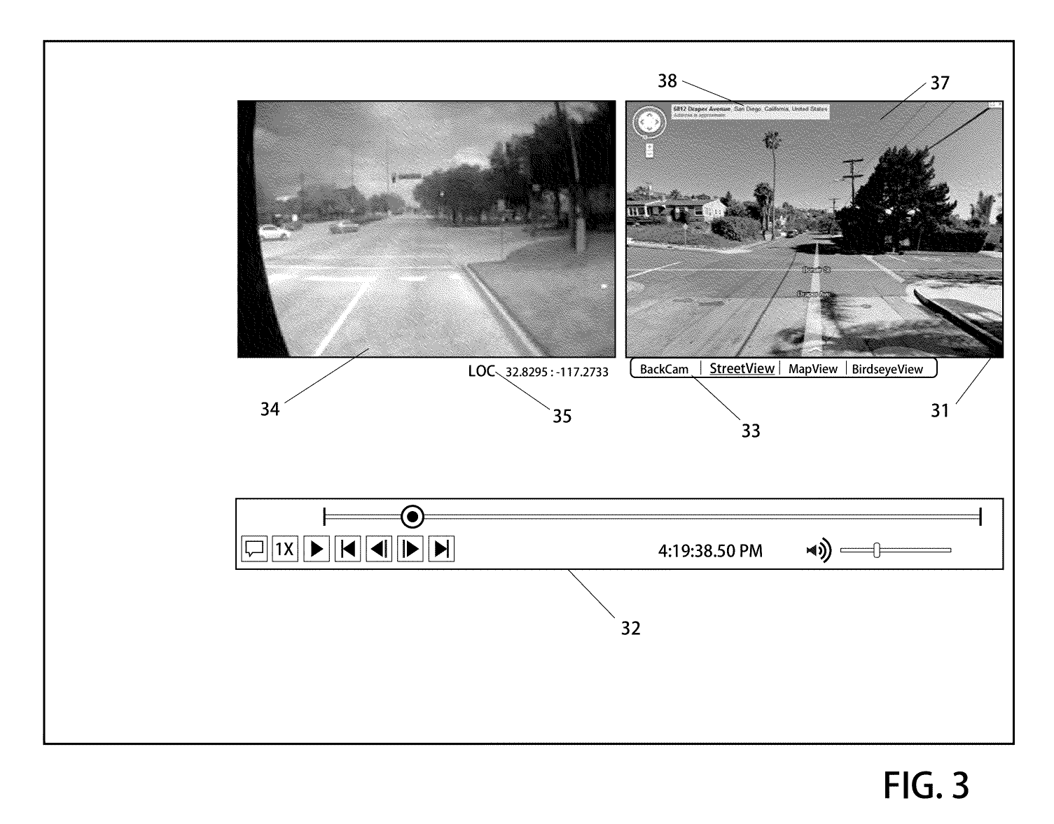

Vehicle event recorders are specifically designed to capture compound datasets relating to exception event of a finite period. Accordingly, most important aspect of these vehicle event playback systems relates to a timeline control object and its relationship with the event dataset and other controls of the graphical user interface. The preferred timeline control object of these systems includes an associated time range equivelant to the time range of the event period. The time range associated with any particular event may vary in length from a fraction of a second to several tens of minutes or even hours. However many events recorded by vehicle event recorders are a few seconds or a few tens of seconds. Timeline control objects in accordance with these teachings will have a ‘start time’, and an ‘end time’ and a continuous time period therebetween. The ‘continuous’ time period between the start time and the end time may further include a finite number of frame instants, frame stops or keyframes. These are discrete moments in the event period or timeline in which an image frame capture has occurred. A timeline control object of these graphical user interfaces is synchronized with the time period over which events and data are recorded at a vehicle event recorder. The timeline control object also includes a ‘start time’ and an ‘end time’ and these are set in accordance with specific related values of the corresponding event record dataset. In the example illustrated as FIG. 1, an event record includes a start time of 4:19:35 and an end time of 4:20:02 for a total event period of 27 seconds.

For improved ease of operation of these timeline controls when playing back vehicle event record data, it is useful to arrange the control to extend an appreciable length of interface regardless of the event period extent.

That is, a timeline control which supports a twentyseven second event is preferably the same size as a timeline control which supports a 10 minute event. Thus a timeline control is ‘normalized’ to the event period without change of its physical size. In view of the particular data contained in an event record dataset, the start time and end time are associated with the timeline control extremities, and 100% of the timeline control length is divided evenly and occupied by the entire event without dependence upon the actual extent of the event period. Accordingly, the timeline control object cooperates particularly with playback of vehicle event recorder output in that the timeline auto-adjusts to normalize for events of any period length. A timeline control object is adapted to match the extent of time period of a specific event under replay and thereafter is further set to agree with particulars of a specific event record. Namely, timeline pip markers 23 which indicate important features of the event record may be distributed about the timeline to provide access to detailed information relating to those important features. Timeline pip markers may be preencoded elements made responsive to mouse clicks. These pip markers may be associated with an instant in time or any time period which is a subset of the entire event period. Further, other control objects of the graphical user interface may be coupled to these pip marker objects and be further responsive thereto, and also be responsive to mouse clicks associated with the pip markers.

### Timeline Replay Instant Indicator Control

Another important element of the timeline object is the timeline replay instant indicator control object. The instantaneous state of a timeline replay instant indicator specifies a replay instant in time, the replay instant to which other controls are bound and responsive. A timeline replay instant indicator marks the present instant of the playback system at any time. The present instant represents any moment in the event period between the event start time and the event end time. For every control which is bound to the timeline control object, the present instant time may be used to set the visual state of the control. The visual state of any control object may be different from each instant of the event period. When the timeline replay instant indicator is associated with another time instant of the event period, either manually or during a preplay execution, each control bound to the timeline control automaticallyl updates its visual state to represent data captured at that moment of the event period. Timeline replay instant indicators are responsive to click-and-drag actions and are further responsive to automated replay controls such as ‘play’ control, ‘fast forward’ control, ‘rewind’ control, et cetera.

### Replay Controls

Replay controls of these systems operate in a conventional way. Those experts in video replay systems will already be familiar with a ‘play’ control button, ‘fast forward’, rewind, ‘loop’, among others. Timeline control objects of these vehicle event playback systems also include such controls which operate analogously with conventional systems.

### Video Players

Preferred modes of vehicle event playback systems presented here include side-by-side playback of a plurality of videos (time series presentation of images). In each of two video control objects, a prescribed video may be played back synchronously. This is particularly useful in gaining a most complete understanding of a complex scene which may have more than one important point of view—such as a driving incident. For example, in a driving incident it may be important to consider the precise timing of event in the view of the driver and further in a view of traffic ahead. When these two views are considered together, an expert reviewer may draw more precise conclusions with regard to the event details.

Accordingly, the event playback systems are particularly characterized by side-by-side video playback controls for playing back videos of two or more unique viewpoints.

Advanced vehicle event recorder systems often include a plurality of video capture stations (cameras) each having an important and unique viewpoint. In some useful versions of vehicle event recorders, a forward-looking' camera is arranged to capture a traffic view ahead of the vehicle and a second reward looking camera is arranged to capture a view of a passenger/driver space.

There is an important time relationship between these two video views because actions taken by a vehicle operator relates in many ways to the traffic and conditions ahead, it is sometimes important to provide a simultaneous playback which is carefully synchronized in time. In this way, one can understand a driver's response to things which may be discovered observable in the forward view. Therefore, preferred versions of these vehicle event data playback systems include a plurality of video players where each of them is synchronized in time to the others and the timeline control object, and with particular respect to the timeline replay instant indicator. Where vehicle event recorders support more than two video recorders, a single timeline control may be used to synchronize those in a similar manner.

An operator/reviewer of these vehicle event data playback systems may ‘scroll’ through discrete video frames of the event timeline by adjusting the playback instant indicator, for example via ‘click-and-drag’ type actions. Accordingly, the graphical user interface devices of this invention includes video playback controls coupled to the playback instant element of any timeline control object. In this way, two separate views about the vehicle environment may be considered simultaneously in a side-by-side arrangement where both views represent substantially the same instant in time as synchronized by the timeline control.

### ‘Virtual’ Videos

While most preferred versions of these systems include side-by-side playback of forward and after views taken from video cameras in a vehicle event recorder, (i.e. ‘real’ video), alternative versions may include at least one video playback display in which a ‘virtual video’ is presented. A virtual video may include a time series of images whereby the images are captured in a system which is not a vehicle event recorder. However, these virtual videos nevertheless do relate directly to the events captured. For example, one type of virtual video in accordance with this teaching may present images having dependence upon the event timeline. Another example may have dependence upon the vehicle position as a function of time. Still another may have a position dependence with prescribed offset. More details of each of these types of virtual videos follow.

### Streetview Player

In one special preferred version of these vehicle event data playback systems, an image series player 31 (video player) is arranged to play a special image series which were not recorded by the vehicle event recorder. Rather, a plurality of still images are recalled from a prepared database to form an image set which may be played in series. Those images when played together as a ‘video’ in the video player constitute a ‘virtual video’ for purposes of this teaching. However, this replay may be well coordinated and having direct dependence with respect to the event record. For example, this virtual special video timeline may be synchronized with the event timeline 32. More importantly, the actual location of a vehicle as recorded by the vehicle event recorder is coupled to the viewpoint from which the recalled images are made.

When the timeline control is set into a ‘play’ mode, the video of actual captured images may appear in a video player control adjacent to a second player which plays the virtual streetview video. This virtual video includes images from the same locations and viewpoints with respect to the event period, but these images may include enhancements and augmentations to bring a more complete understanding of the actual event. In one example, streetview images provided by a service like Google's StreetView system can be recalled in view of a plurality of position measurements taken by the vehicle event recorder. For this plurality of locations (vehicle's location as measured by a GPS for example) captured over the period of any particular event, a streetview image from a corresponding location may be recalled from the image database. Each recalled image is then assigned a time instant corresponding to those times from which the playback timeline 21 is comprised to assemble a virtual video of streetview images which directly corresponds to the video actually captured at the vehicle event recorder cameras. One advantage lies parly in the clarity of the recalled images which may have been provided on a nice sunny day in comparison to images captured by the vehicle event recorder which might be of inferior clarity due for example to inclement weather including fog or sun glare. Further, nighttime may similarly block a clear view. Still further objects in the scene during the event capture such as a large truck. Further advantages are to be realized in view of the labels which might be incorporated with the prepared streetview images. For example, address label 28 indicates a street address most closely associated with the image viewpoint.

### Video Player Tabstrip

Since it is generally inconvenient to view many videos simultaneously, these players typically have two players side-by-side with the precise video type selectable in the interface by way of a tabstrip control 33 an example which includes four tab selections. In agreement with which tab is selected and triggered, the video playback may be switched between the possible video presentation types. However, despite the selected video type, the player presents a synchronized playback of both real and virtual videos in agreement with the event period and the timeline control.

### Mapview Player

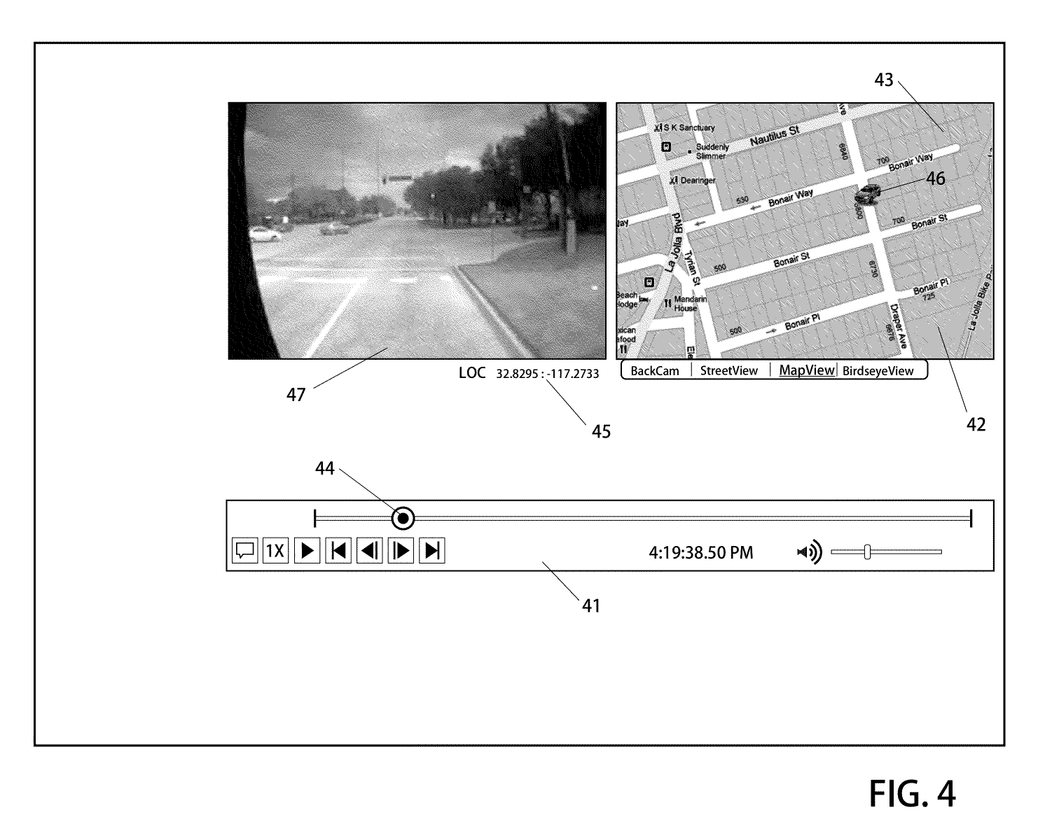

There is another type of important virtual video supported by these playback systems which relates to moving maps—a mapview virtual video is depicted in FIG. 4. In a fashion similar to that described in the streetview embodiment, a plurality of map images are prepared and saved to form an image series consistent with an event record dataset. In particular, both the vehicle location and the event timeline 41 are considered informing a series of map images suitable for playback in a mapview video player 42.

A separate map image 43 with appropriate scale, size and orientation is presented in the viewer for every discrete instant of the event period as represented in the event timeline. When playback instant control 44 is moved to another time (constant) of the event timeline, the vehicle also moves (in most events). The new vehicle location 45 implies a new map and a separate map image may be allocated and displayed for that time instant. The vehicle's position within the map may be indicated by an icon marker 46 to reflect the position of the vehicle as measured by the vehicle event recorder. In a an event replay, the series of map images may be played back synchronously alongside the actual forward view images captured at the vehicle event recorder camera.

A mapview player in accordance with this teaching is particularly useful when it is arranged to present maps with enhancements and markings which are derived from information in the event record dataset. For example, when actual vehicle speeds are compared to local speed limits, a determination is possible with regard to all regions in which a speed infraction occurs. A graphical representation of same may be included superimposed with maps presented.

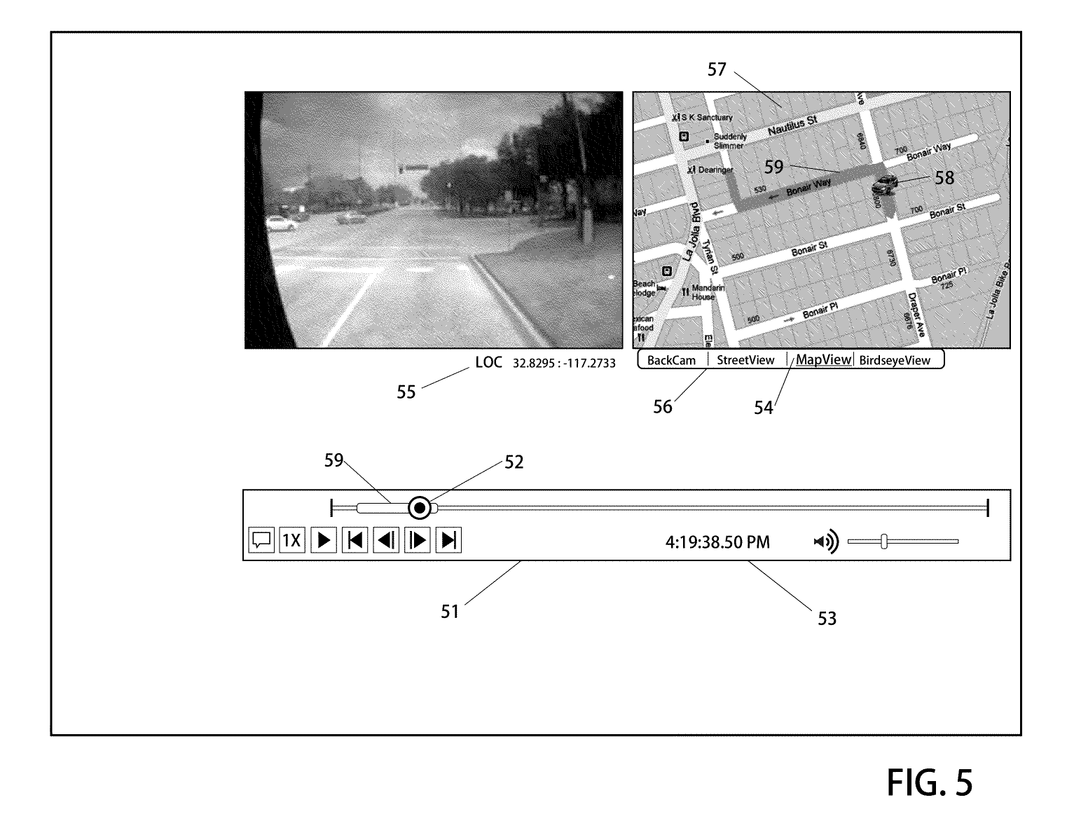

With reference to FIG. 5, timeline control object 51 agrees with the event record dataset from a vehicle event recorder. A playback instant control 52 marks an instantaneous moment of the event period. At the moment 4:19:38.50 p.m. indicated in a numeric label control 53, the vehicle GPS system determined the vehicle location at latitude 32.8295 and longitude −117.2733 as recorded by the vehicle event recorder's position determining system and position is reported numerically at position label control 54.

With the video player set into a mapview mode 55 by a tabstrip tool 56, a map image 57 suitable in scale and location is presented with particular regard to the vehicle's location at the corresponding instant in time. An icon image of a car 58 marks the precise location in the map. In addition, a spatial highlight 59 for example in red transparent markings (highlighting portions of Bonair and Draper streets in the image), is superimposed on the map image to mark regions where speeding infractions have been identified.

Timeline marker 59 designates a finite period of time within the event period when the speeding occurs. Thus, some timeline controls of these systems include marker objects aligned and cooperative with elements appearing in virtual videos. This cooperation is due to careful associations with time instants within the event period.

Both the streetview player and the mapview player offer important advantages in reaching a complete understanding of particulars of a scene. Indeed where these are additionally augmented based on information collected by a vehicle event recorder, they are of particular advantage.

However, they do not complete the range of useful video playback players of this invention. Another important virtual video player useful in these systems may be characterized as a bird's eye view virtual video player.

### Bird's Eye View Player

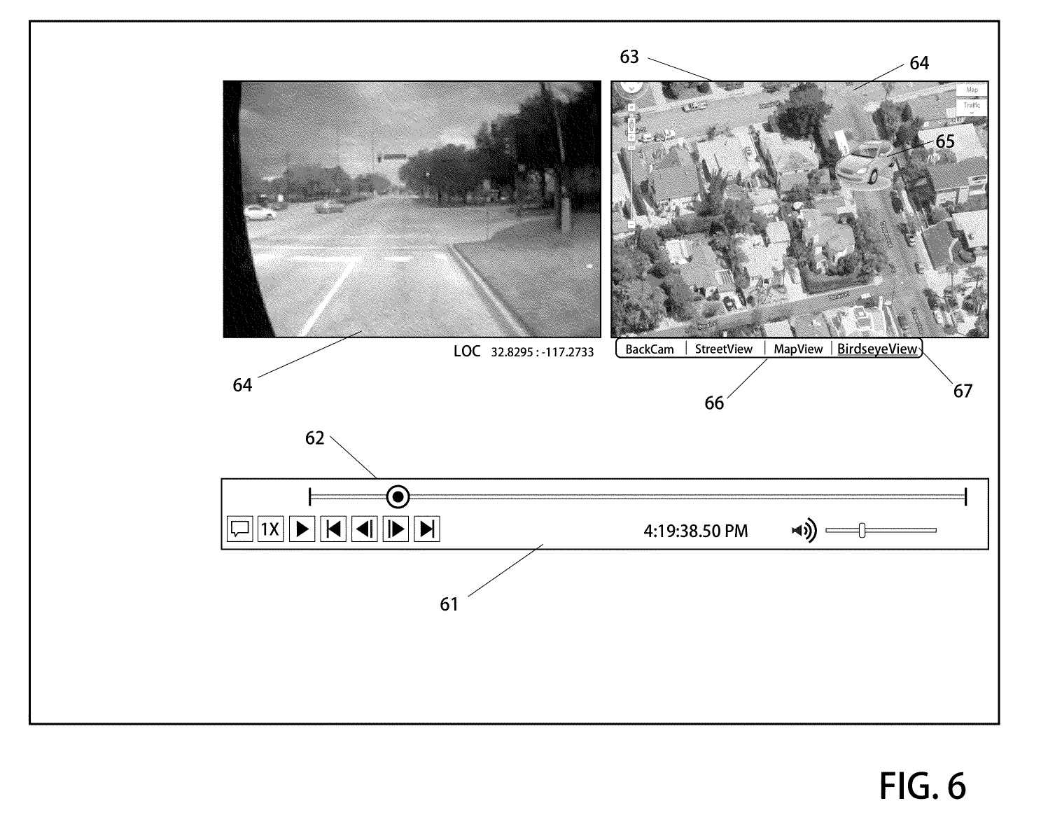

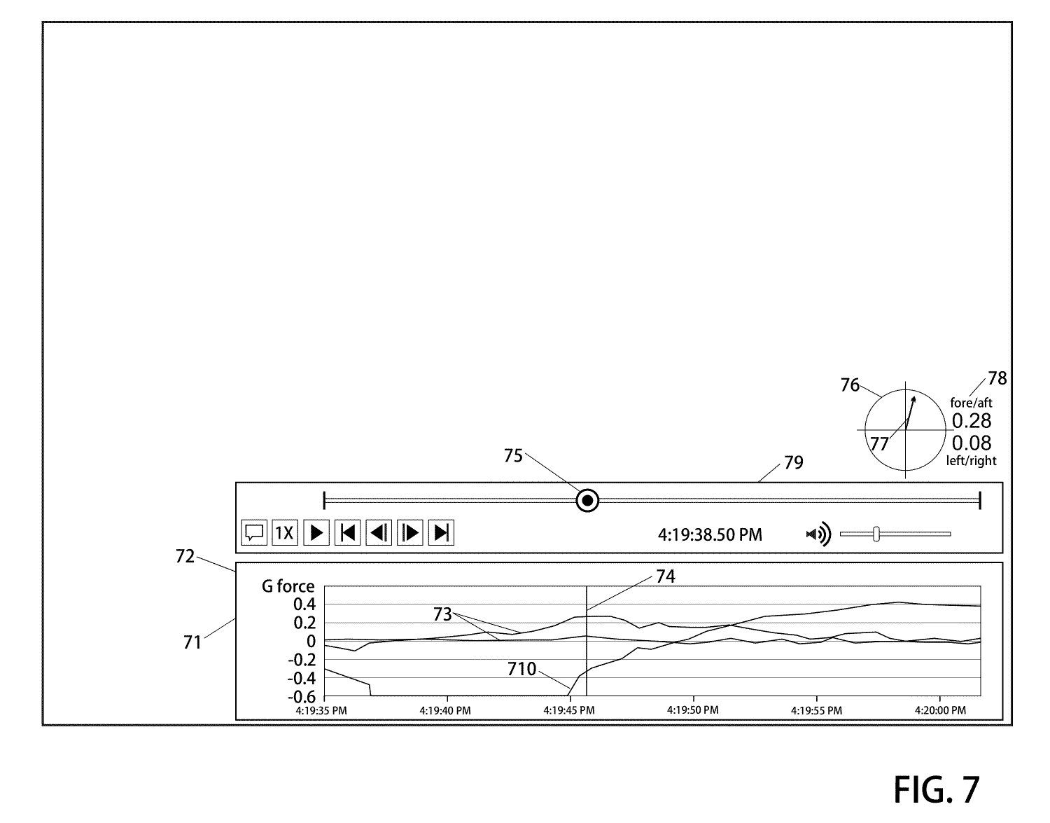

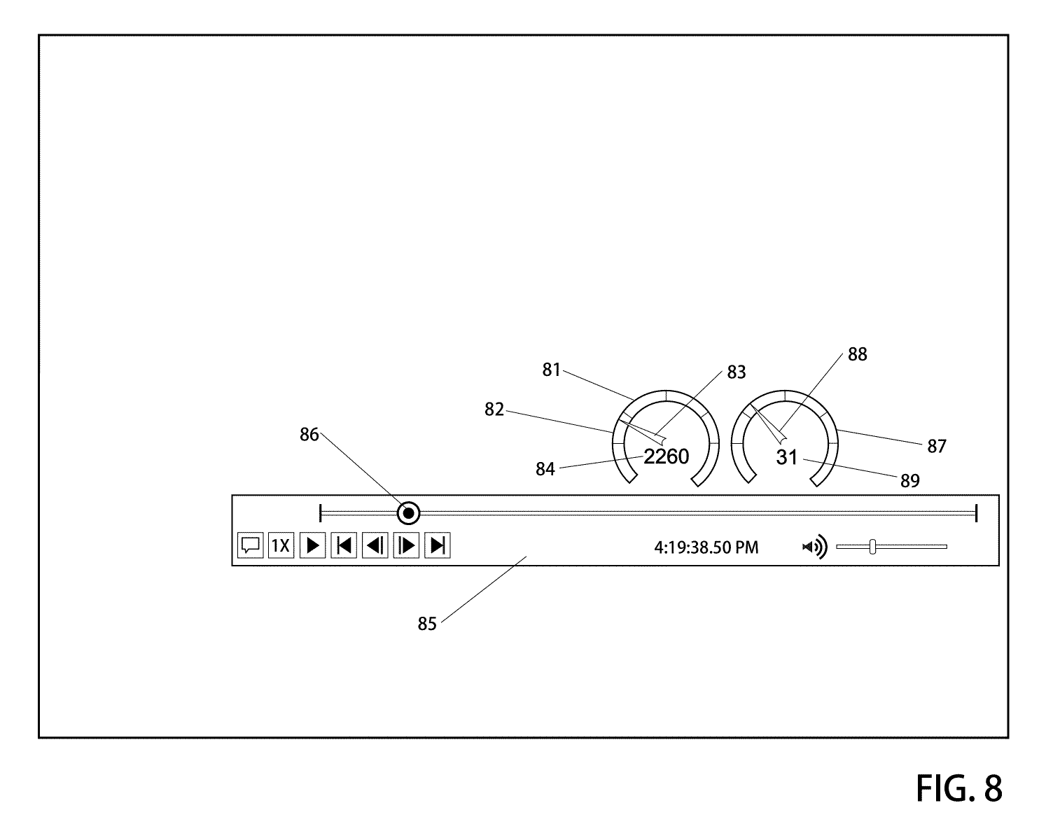

Illustrated in FIG. 6, a bird's eye view video player of these systems includes images taken from an elevated viewpoint for example images made from an airplane or satellite. In consideration of the vehicle's time-dependent position as measured and recorded by a vehicle event recorder, images are selected from a prerecorded database of so described images.

Timeline control 61 specifies one instant in time by a playback instant control 62. Video player display 63 includes an image 64 and a ‘car’ icon marker 65 to indicate the location of the vehicle at the capture time 4:19:38.50. When tabstrip 66 is used to set the video player into a bird's eye view mode 67, an image series of perspective images made from altitude is played back in time with respect to the event timeline. As the event player executes playback of event data, moves over the event period, bird's eye images and marker icon are updated for each instant of the timeline to reflect appropriate views of the event scene.

Because the precise image viewpoint is highly selectable (in part due to some very clever image processing tricks), it is possible to specify that the viewpoint be constant at a virtual location, for example 100 meters behind the car and 50 meters above the car, and the view direction is pointing in the direction of travel with respect to the vehicle. In this way, the bird's eye view playback virtual video can be envisioned as if a helicopter video camera followed the car throughout the event to make the video images. A reviewer gains a most clear understanding of the event environment as presented in a synchronized manner alongside with other event record information.

Accordingly, these vehicle event data playback systems include both real view video players and virtual video players which are arranged to interact with exception event data recorded in vehicle event recorders. Each of these specialized video players provides a time synchronized image series in conjunction with a visual presentation of other important related event record data.

While the preceding detailed description nicely sets forth several novel video playback control objects, the following description is directed to other aspects of these vehicle event playback systems which are not based upon data from image systems. Rather, the graphical user interface control objects presented herefollowing express non-image data from a plurality of diverse sources. In some cases, these diverse sources include onboard systems. In other cases, information sources may include those which are external with respect to any vehicle and its vehicle event recorders.

In a first instance, graphical user interfaces of these playback systems having control objects bound to vehicle onboard systems are described in detail. These come in two primary types including: 1) control objects bound to data from sensors deployed as part of a vehicle event recorder apparatus, for example, a vehicle event recorder may include accelerometers which measure G-force levels in two orthogonal spatial dimensions while a vehicle is being used; and in a second type of control object, 2) a control object is bound to vehicle subsystems characterized as those installed by a vehicle manufacturer. Data provided by way of a vehicle's OBD and ECU systems are received, managed, parsed and time-stamped at a vehicle event recorder which forms a dataset to which certain important control objects of the graphical user interfaces may be bound.

Yet another type of data which may be included is characterized as calculated data. Data generated by analysis modules of the vehicle even recorder or coupled servers, such as wasted fuel estimate, triggers, calculated fuel consumption from mass air flow sensors, et cetera, may also be presented in these event player systems.

Some important control objects of these systems are bound to data sources not part of any vehicle event recorder system and indeed totally external with regard to vehicle subsystems. These control objects may be nevertheless implicitly strongly coupled to event record datasets which are subject to playback in these devices and methods. In one illustrative example, a notation system which associates an expert reviewer's comments and notes with certain portions of an event record in a note field or notation control object may be coupled to receive data therefrom. Details of each of these types follow.

### Acceleration (2-D G-Force) Control Object

In one important version, a control object or plurality of control objects are coupled to the timeline control and thus the event period to affect time synchronization between these. Acceleration control objects are preferably arranged to visually show acceleration data collected during an exception event captured at a vehicle event recorder. With respect to acceleration data collected in a vehicle event recorder, it is most useful to present this type of information in two fashions. First, it is useful to present instantaneous acceleration data associated with an instant of time during the event period. In a second fashion, acceleration data collected over the entire event period (or finite subset thereof) is usefully displayed in a graph of two axes. Force data is preferably presented in a form where the abscissa of which is preferably time, and the ordinate force.

A first acceleration control object includes a line graph 71 representation of acceleration data into orthogonal directions. ‘G-force’ or acceleration is plotted versus time to form line representations 73 of acceleration data. A playback instant indicator 74 is synchronized with the playback instant indicator 75 of the timeline control object both spatially and with respect to displayed data.

Another related acceleration control object 76 which expresses acceleration data in an alternative visual form is additionally illustrated. This 2-D expression of instantaneous force includes a pointer 77 which gives a visual representation of force in both forward/aft and left/right directions 78.

Both versions of acceleration control objects are bound to information in the event record dataset whereby synchronization is realized with respect to the timeline control and all other control objects similarly bound including the video display control objects. Accordingly, control objects may be arranged to present instantaneous data as well as plots of data over time. In both cases, these controls are bound and responsive to the playback timeline 79.

### Factory-Installed Vehicle Subsystem Data

Highly advanced vehicle event recorder systems produce information-rich event record datasets. Event record datasets of high performance vehicle event recorders sometimes includes data captured at vehicle subsystems, for example by way of the onboard diagnostics and engine control unit. In vehicle event recorder systems so equipped, data captured at various vehicle subsystems may be time-stamped in a scheme coordinated with the event period and additionally with video frame capture rates. Where such data is carefully time-stamped, it is in good condition for synchronous replay via these vehicle event data playback systems.

Accordingly, these vehicle event data playback systems are particularly suited for playback of vehicle event records having been formed with time-stamped data from factory installed vehicle subsystems. In particular, some vehicle event recorder systems are arranged to capture engine speed data and further to associate a time instant with speed data measurements. In preferred versions, engine speed in ‘revolutions per minute’ or RPM, may be read from the ECU by way of an OBD coupling to which a vehicle event recorder may be connected. In some important alternative versions, engine speed measurements may be made via ‘aftermarket’ installed sensors and vehicle subsystem detector which can obviate need to directly couple with the ECU. In either case, when event record datasets which are compatible with these playback systems are prepared and recorded, engine speed measurements each must be associated with an instant in time or “time-stamped”. In systems common in the art where engine speed is recorded, engine speed is generally recorded without regard for simultaneous and synchronized playback. In those systems, engine speed data is not necessarily provided with any association with time. Because it is a goal of these playback systems to playback data in a highly synchronized fashion, it is necessary to time stamped data in this way. Where vehicle subsystems, for example engine tachometer does not provide measurement data at a rate equal or similar to video camera frame rates, data smoothing and or data averaging may be used to improve a dataset or portion thereof to make it better cooperate with the objectives of these playback systems which necessarily include a discrete number of time instances on an event timeline. Common vehicle tachometers do not face this restriction and are otherwise free to take measurements at any convenient rate includes those rates having unequal periods between data measurements. Because time synchronization is an important part of these playback system, it is necessary to account for the precise moment any measurement is made in order that orderly time synchronized playback is possible.

Nearly all modern vehicle manufacturers include advanced electronic systems with many of the vehicle's subsystems. For example, a mechanical accelerator pedal often includes a transducer from which pedal position is readily measured. However, electronic data which might exist within a vehicle's proprietary electronic control schemes is not always readily available on third-party networks. Although industry standards are carefully provided, discrepancies remain in capture of such data continues to be prohibitively complex or expensive. For this reason, most vehicle event recorders are unable to record information relating to certain vehicle performance parameters for example an odometer or fuel flow meter on light duty vehicles.

In special cases where a vehicle event recorder can be successfully coupled to vehicle electronic subsystems whereby they operate to receive this data, they must be further adapted to carefully pass the data and manage a timestamp scheme in conjunction with the particular nature of the vehicle event recorder. For example, if a vehicle event recorder operates with a video frame rate of 30 frames per second, but the factory installed throttle position data only update three times per second, a data recording scheme must be set to rectify timing issues between these independent data sources so that an event dataset accurately reflects an ‘instantaneous’ time value for all data elements.

### Engine Speed and Vehicle Speed Control Objects

To date, there has not yet been any vehicle event recorder system which records time-stamped engine speed data. As such, synchronized playback of same has been impossible. However in systems disclosed herein, engine speed information is expressed graphically in a visual presentation and additionally in an alphanumeric expression in an engine speed control object 81. An engine speed control object of this example is comprised of graphical portions and alphanumeric portions. An analog arc 82 provides a range continuum upon which instantaneous magnitude may be displayed by a pointer 83. A digital numeric readout 84 allows an instantaneous report of engine speed for any instant of the event timeline 85. Playback instant indicator 86 may be moved (e.g. via mouse type computer pointing peripheral device) to any point along the timeline and engine speed control object which is bound to the timeline is updated to indicate the engine speed recorded at that particular time.

In a similar control object, vehicle speed control object 87, pointer 88 yields an instantaneous value of ‘31 mph’ on an analog scale while a digital numeric value 89 is also provided at vehicle speed label.

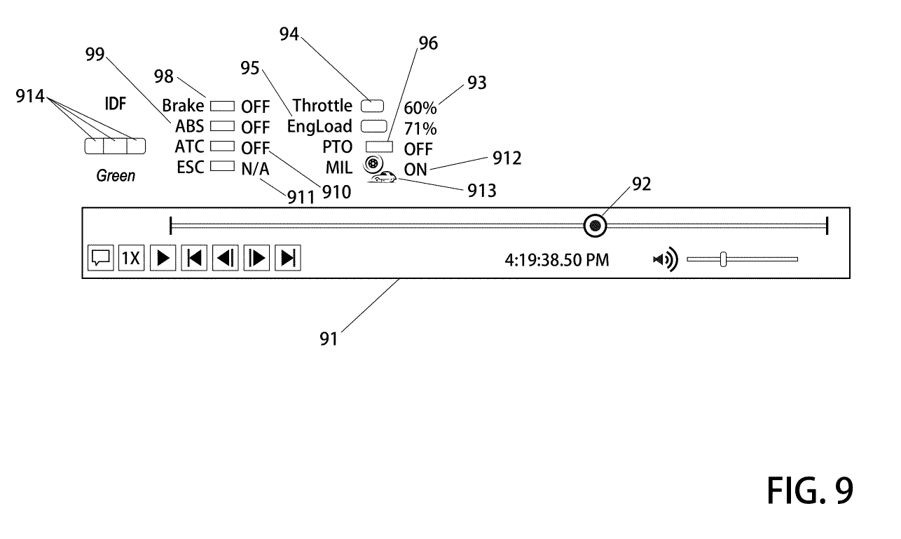

Event records which are compatible with and may be played by these vehicle event playback system include measurement data from the groups characterized as those including: throttle position data, engine load data, power takeoff system data, malfunction indicator light system data, brake system data, antilock brake system data, automatic traction control system data, electronic stability control system data and excess fuel consumption system data among others. FIG. 9 illustrates. An event timeline 91 having playback instant indicator 92 set at time corresponding to 4:19:53.00 p.m. is coupled to a plurality of important control objects. Each of said control objects are arranged to express time-stamped data in a visual presentation which may include both graphical and alphanumeric representations of same.

### Throttle State Control

Most vehicle event recorder systems are incapable of recording data related to throttle position. However, this remains an important factor in many collision scenarios and also fuel analysis. For example, it is sometimes useful to understand how much time passes between the time a red light traffic signal appears (detectable via forward view video review—for example) and the time a vehicle operator disengages application of power, i.e. removes foot from an accelerator pedal. Because it is very difficult to arrange a custom sensor to detect accelerator position, nearly all types of vehicle event recorders include datasets devoid of this critically important data.

While access to this information is sometimes available on a vehicle's ECU system, to date it has been prohibitively difficult to couple vehicle event recorders to the ECU of modern vehicles. Where that has been achieved, the dataset produced by such advanced vehicle event recorders must include time synchronization management schemes with respect to its video camera. These systems include time-stamped data regarding throttle state where event record dataset having such timestamp throttle state data are available, these vehicle event data playback systems are cooperative and provide graphical user interface controls which are suitably responsive to such event record datasets.

A graphical user interface with a throttle state control object provides graphical expressions of throttle states. The control object is further coupled to an event timeline and corresponding event timeline control whereby the instantaneous throttle state for any time in the event period may be selectively displayed by the control.

In one preferred version of such throttle state control object, both an instantaneous numeric value 93 (digital) and a graphical expression 94 (analog) of the throttle state is given for each instant of the timeline control. When the playback instant indicator is moved to another position of the event timeline, the throttle state control is updated such that data represented there is updated in synchronization with other controls of the graphical user interface including video.

The video of video playback control object indicates a red traffic signal has occurred at 4:19:44, we can see by sliding the playback instant control to that moment of the timeline that the throttle state remained at 100% (recall FIG. 1). However, when the playback instant control is advanced further down the timeline to about 4:19:46, we can see the throttle position is at 0%.

This may be verified further in consideration of vehicle speed 710 data presented in a continuum chart. In it one can see that the vehicle begins to decelerate just before 4:19:45. While the acceleration data is a good indicator of when the driver releases the throttle, it remains imprecise. To learn the precise time the throttle was released, the playback instant control must be manipulated to indicate a time prior to 4:19:45 and the throttle state control must be reviewed. This control more accurately tells a more full story as it relates to the question “when did the driver respond” rather than the question “when did the vehicle respond”. Accordingly, in some circumstances a throttle state control well synchronized with related data and bound to a timeline control unit will tell the full story which otherwise could not be known in the absence of throttle state information.

Similarly, a graphical user interface engine load control object 95 may be included in some versions of these vehicle event data playback systems. A sensor installed by a vehicle manufacturer produces data to indicate engine load on a scale from 0% to 100%. Data from the sensor is available on the ECU via the OBD. Data which indicates engine load may be periodically detected or captured and added to the event record dataset produced by advanced vehicle event recorders. This step must be done with particular attention to time calibration and/or time synchronization. For example data from the OBD may arrive at irregular intervals. Or the data may arrive with extreme time jitter between successive measurements. In all cases, for this data to be useful in playback systems taught herein, it must be carefully synchronized with other events encoded in event records. It is not enough with respect to the present vehicle event data playback systems to merely collect multiple readings of engine load but rather because of the particular playback characteristics suggested here, engine load data (among other) must be carefully time stamped before being included as part of these event records. The benefit of engine load data is to help understand how heavily loaded the engine is given its speed (RPM). This could inform the user if the vehicle was heavily loaded, whether the driver had excess power that he could have used for an evasive maneuver, et cetera.

### Power Takeoff Control

Another information source which relates to vehicle performance which may be replayed in these event data playback systems relates to power distribution. Sometimes it is important to know when engine power is needed by and being delivered to auxiliary systems. If vehicle engine is delivering power to coupled power consuming subsystems (e.g. refrigeration, hydraulic actuator, et cetera) an event record may be configured to indicate the status of any power takeoff systems.

In certain versions, a power takeoff indicator may be embodied as a binary indicator. A power takeoff control object arranged to indicate binary states for every instant of an event timeline may include a graphical portion 96 and an alpha numeric portion 97.

Other control objects are provided similarly to visually present data collected from vehicle subsystems which additionally may include: a brake indicator control object 98, an antilock braking system ABS control object 99, an automatic traction control ATC control object 910, and an electronic stability control ESC control object 911. Each of these graphical user interface control objects may be driven by data contained in an vehicle event recorder event dataset and be responsive thereto. Further, each of these controls may be bound to the timeline control object whereby visual presentation of data in all controls is time synchronized. Still further each of these controls may present data in both graphical and/or alphanumeric presentations.

One important aspect of these control object relates to their graphical nature. In systems which produce data having a limited few states, it is sometimes convenient to present the data states via prescribed and/or preconfigured icon symbols. For example a malfunction indicator light (MIL) system might operate to provide driver alerts with respect to five types of malfunction in addition to a binary ‘ON’-‘OFF’ value 912. A low tire pressure icon 913 may be displayed to indicate a malfunction of a particular nature. The control object which remains synchronized with event playback, will be showing both its ‘ON’-‘OFF’ indication and malfunction type via the displayed icon.

### Excess Fuel Consumption Control Object

Very advanced vehicle event recorders sometimes include an excess fuel consumption indicator. When a driver takes an action which is determined to be one associated with excess fuel consumption, an excess fuel consumption indicator may provide a driver with instant feedback to signal the condition. Where vehicles are equipped with such devices, they may also provide data to be included in a vehicle event recorder event record dataset. Accordingly, these vehicle event data playback apparatus also include a special instant driver feedback control object 914. Because feedback is sometimes provided as a three color scheme for example, simplest versions of instant driver feedback control object may similarly express these discrete feedback states. This control object is another good example which illustrates the value of highly visual playback of vehicle event records. When an indicator is given to a driver to alert him that a maneuver has caused excess fuel consumption, it is important to understand in detail a driver's detailed response in order to administer appropriate coaching. With these playback systems, it is very easy to visualize and completely understand details associated with vehicle operation. Thus a reviewer/coach can see clearly decipher a driver response to instant feedback relating to fuel consumption maneuvers.

While most controls described to this point have been bound to data collected in vehicle event recorder systems, it is not a necessity that information and data be sourced in this fashion. Indeed, there are very important information sources not part of the vehicle event recorder which nevertheless contributes to data playback in these systems.

### Notations Field Control Object

High-performance vehicle event recorders record data from vehicle systems and form an event record which details many aspects of vehicle and driver performance. In some of these systems, a human reviewer studies video captured in an event record and prepares notes and observations in accordance with his study of the event videos. In addition to these notes, a human reviewer also sets discrete values for some prescribed parameters—i.e. a binary value for seatbelt on/off. Some of these notes are general to the entire event period (i.e. a ‘no seat belt’ infraction) and others are particular to certain time portions of the event period or a single instant in the event period. Once prepared, the notations become appended to and part of an event record. When event records are played back in these data players, special provision and facility is made for these notations.

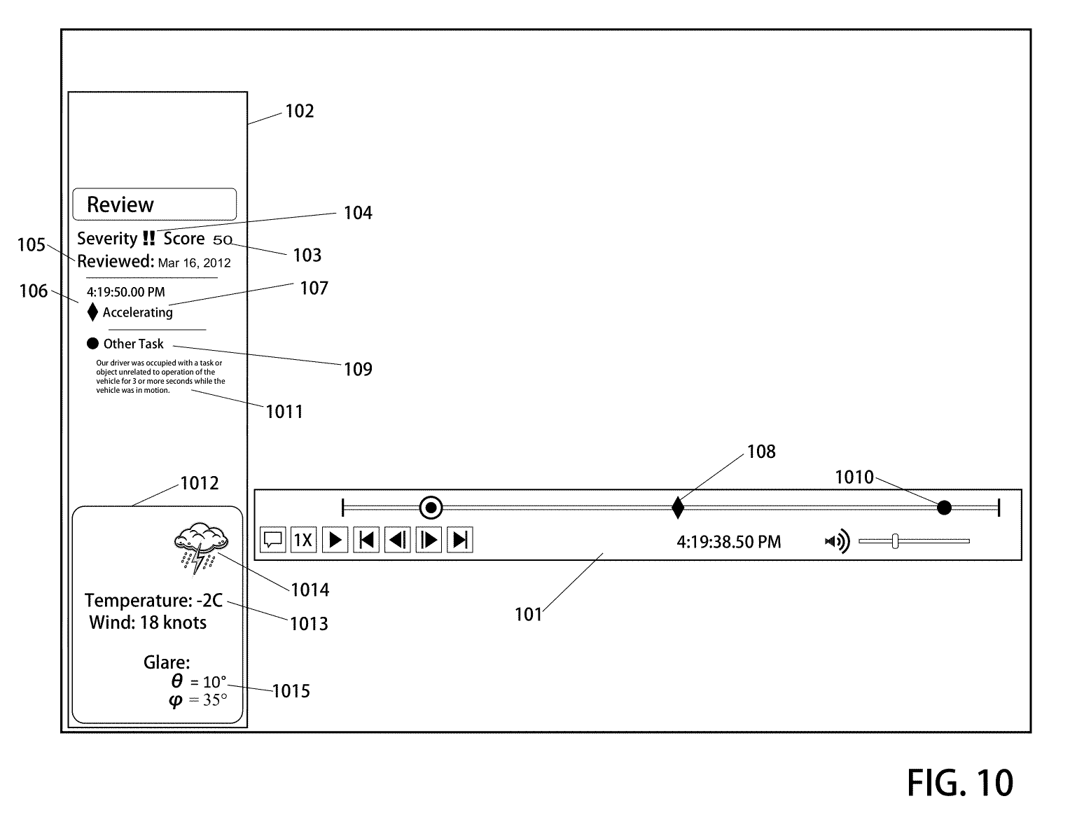

FIG. 10 shows one illustrated example of a timeline control 101 coupled to a notation field control 102. The notation field may include numeric review data such as a score value 103 and icon indicator 104 related to severity, a review date label 105 and a note list 106 containing therein a plurality of note entries (two notes entries are shown in the example).

A first note 107 relating to an occurrence of “aggressive accelerating” is coupled to timeline marker pip 108 while “other task” notation 109 is coupled to timeline marker pip 1010. Finally, note field 1011 contains text which describes the reviewer's detailed observations as those relate to the ‘other task’ note. Since these notes relate to specific parts of the event period, event playback is improved when note text is appropriately displayed with respect to the note time association during the event data playback.

Access to various of these notes may also be affected by pointing and clicking on the timeline pip marker elements. For example, if a user were to click on the diamond shaped marker pip, the “other task” note closes and the “aggressive accelerating” note opens to reveal text of that note. In this way, access to all appended notes is readily available via timeline cues.

The notation control object described in the foregoing graphs is illustrative of a first kind of information whose source is not from onboard a vehicle but nevertheless is highly related to a vehicle event playback. It is not the only of such source which may provide information related to a vehicle event but not part of the vehicle, any of a vehicle's subsystems, nor a vehicle event recorder.

Indeed another important information source external from the vehicle includes one which reports on environmental conditions related to the time and location of the recorded event. In one type of environment control object 1012, the state of the weather is reported as recorded in remote weather reporting stations. For example, if an event recorder produces an event record with precise location and time information, a weather station can report approximate ambient temperature at the text label 1013. It could further report approximately whether or not the roadways were dry or wet at that time via icon display 1014. It could also indicate, albeit by a bit of prediction, whether or not the roads were icy or snowy. These systems may indicate whether or not the event occurred during a windy day. In view of sidereal time, and in further view of a vehicle's direction of travel (as recorded by a vehicle event recorder), this control object may indicate the level of sun glare 1015 which may have hindered a driver's visibility during an event. A weather reporting station accessed via the Internet after an event record is made, may provide such pertinent data.

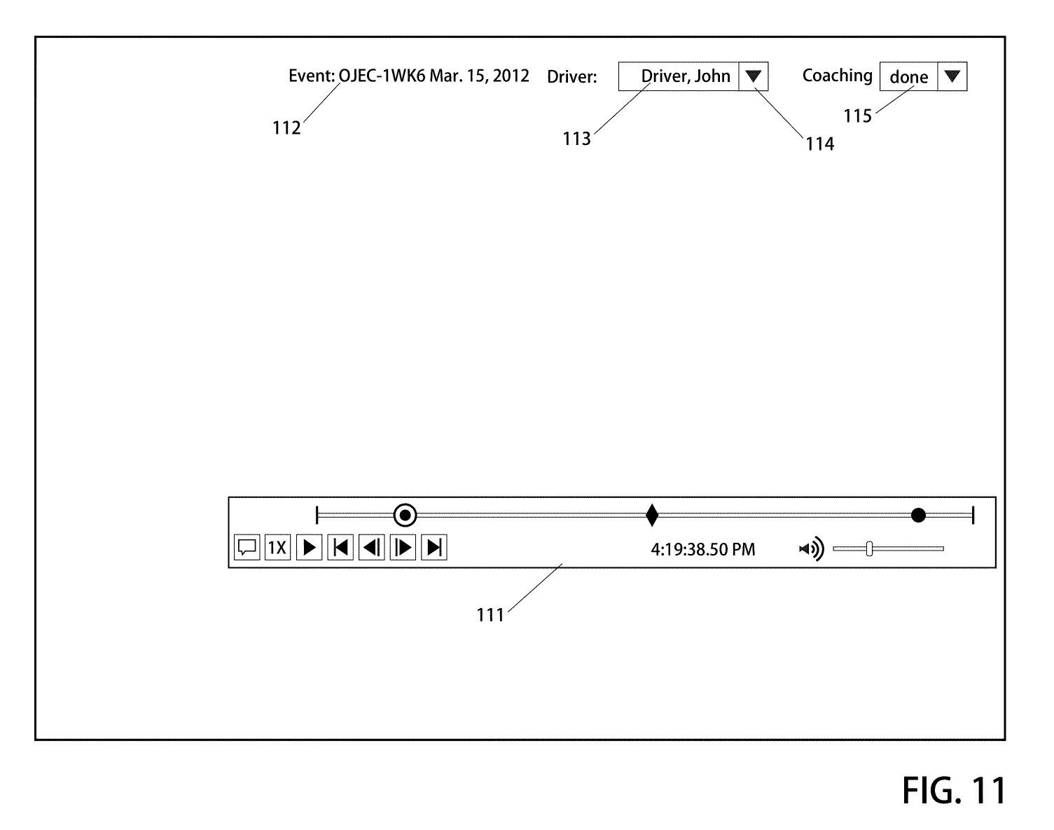

FIG. 11 illustrates a few additional important features. For reference, event timeline control 111 is illustrated in this drawing. A ‘now playing’ event label 112 identifies an event which is currently being addressed by or is subject of the event data player. A driver 113 drop-down type selection box 114 permits operators of these playback systems to select other fleet drivers to which these playback systems may be pointed to view events associated with that particular driver. Another selection box 115 enables an administrator to further mark an event with additional notation to indicate a training status.

One will now fully appreciate how vehicle event record playback systems may be arranged and configured to present compound event data related to vehicle and driver performance in a highly detailed and time synchronized visual presentations. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1) Vehicle event data playback apparatus comprising:
a logic processor;
a graphical display device; and
an graphical user interface system,
said graphical user interface system comprising a plurality of control objects, at least one control object being responsively coupled to a vehicle event record whereby the visual nature of coupled controls depends upon data values in said vehicle event record.

2) Vehicle event data playback apparatus of claim 1, said graphical user interface is further characterized as an interactive graphical user interface whereby a user/operator may engage and manipulate elements of the graphical user interface and the interface is responsive to user/operator actions.

3) Vehicle event data playback apparatus of claim 1, said vehicle event data playback apparatus further comprises a timeline control object, said timeline control object having a start time, an end time, and a discrete number of time instants therebetween.

4) Vehicle event data playback apparatus of claim 3, said plurality of coupled control objects expresses acceleration.

5) Vehicle event data playback apparatus of claim 4, on control expresses a graphical and alphanumerical instantaneous acceleration data, and another control includes an expression of acceleration over a continuum of time equivalent to the event period.

6) Vehicle event data playback apparatus of claim 3, control objects are coupled to data received at a vehicle event recorder coupled to a vehicle OBD/ECU.

7) Vehicle event data playback apparatus of claim 3, further comprises a control object characterized as an engine speed control object which is responsive to vehicle engine speed data provided by a vehicle event recorder event record dataset.

8) Vehicle event data playback apparatus of claim 7, said engine speed control object is arranged to provide a digital and analog expression of engine speed.

9) Vehicle event data playback apparatus of claim 7, said engine speed control object is arranged to provide graphical and alphanumeric expression of engine speed.

10) Vehicle event data playback apparatus of claim 3, further comprises a control object characterized as a vehicle speed control object which is responsive to vehicle speed data provided by a vehicle event recorder event record dataset.

11) Vehicle event data playback apparatus of claim 10, said vehicle speed control object is arranged to express vehicle speed as a graphical and alphanumeric display.

12) Vehicle event data playback apparatus of claim 10, said vehicle speed control object is arranged to express vehicle speed as an analog and digital display.

13) Vehicle event data playback apparatus of claim 3, further comprises a control object characterized as a throttle position control object which is responsive to the mechanical position of a throttle pedal as provided by a vehicle event recorder event record dataset.

14) Vehicle event data playback apparatus of claim 13, said throttle position control object is arranged to express throttle position as a graphical and alphanumeric display.

15) Vehicle event data playback apparatus of claim 13, said throttle position control object is arranged to express throttle position as an analog and digital display.

16) Vehicle event data playback apparatus of claim 3, further comprises a control object characterized as an engine load control object which is responsive to the load of a vehicle engine as provided by a vehicle event recorder event record dataset.

17) Vehicle event data playback apparatus of claim 16, said engine load control object is arranged to express engine load as a graphical and alphanumeric display.

18) Vehicle event data playback apparatus of claim 16, said engine load control object is arranged to express engine load as an analog and digital display.

19) Vehicle event data playback apparatus of claim 3, further comprises a control object characterized as a power takeoff system control object which is responsive to a power takeoff system sensor as provided by a vehicle event recorder event record dataset.

20) Vehicle event data playback apparatus of claim 19, said power takeoff control object is arranged to express power takeoff system status as a graphical and alphanumeric display.
